(19) United States
(12) Patent Application Publication
(10) Pub. No.: US 2005/0216475 A1
(43) Pub. Date: Sep. 29, 2005

(54) Method and apparatus for internet protocol for providing personal and business store front registration and sales services through personalized or computer generated identification numbers

(76) Inventor: Ricky Dean Overton, Hastings, NE (US)

Correspondence Address: Ricky D. Overton;c/o Dennis Clausen, 403 Fink St., Glenvil, NE, 68941, US

(21) Appl. No.: 11/079,490

(22) Filed: Mar. 15, 2005

Related U.S. Application Data
(60) Provisional application No. 60/555,375, filed on Mar. 23, 2004.

(51) Int. Cl. G06F 7/00

(52) U.S. Cl. 707/10

(57) ABSTRACT

An Internet information method which includes a web site coupled to a first user intranet point and a second user Internet point. The first user point is coupled for providing managed information to the web site such that a selected identification string and password provides user access to all of the managed information. The second user Internet point is coupled for providing access to the managed information such that a selected identification string provides user access to a limited portion of the managed information.

### BACKGROUND

The disclosures herein relate to accessing an Internet site and more particularly to managing and updating information at the site from a first access point, and accessing of the information from a second access point.

Information and data can be accessed by either the first user or second user from any remote access server which provides access to the Internet.

Upon reaching the website, either the first user or second user instructs the server to accomplish various tasks by receiving an identification string from its communication port, the string having been entered by the remote user from a remote computer. This includes the use of any voice recognition software that assists in accomplishing the various tasks. The string either identifies the remote user as being a first user for accessing and managing information or a second user for accessing the information provided by the first user.

### OBJECTS AND ADVANTAGES

An important aspect of exchanging merchandise (hereby described as direct selling) whether it be via sales, auctions or trade, is the accessibility of the information to the potential buyer. Especially as it pertains to using newspaper ads, FOR SALE, FOR RENT or GARAGE SALE signs to inform the buyer of merchandise that is available for exchange. The merchandise owner can immediately provide the buyer with up to date information from any location worldwide that has Internet accessibility. Providing an immediate, efficient method of connecting sellers and buyers will be beneficial to both parties for several reasons. i.e. Is the item listed in the paper still for sale or rent? Will the seller assist the buyer if they are handicapped or cannot physically go to inspect the item? Can the buyer view the merchandise before making a personal visit to inspect the item? Will the owner take personal checks and will they guarantee or fix something that is broken?

Another major element of direct selling is providing a personal history of the merchandise being sold. i.e. is the item being sold new or used and when did the owner purchase the item, how well has it functioned during ownership, is there a repair or maintenance history of the item and is the warranty transferable, is there a lease to sign and how much deposit is required before moving in, does the vehicle have the needed equipment for the buyer and what does it look like.

Therefore, by providing an apparatus and method for providing information at a site, continuously managing and updating the site information from a first access point and providing contact information to the second user point, coupled with the ability to provide immediate, up to date information for the buyer when requested, is insurmountable.

### SUMMARY

One embodiment, accordingly, provides a method and apparatus for accessing and maintaining an Internet site containing information which is continuously updated and managed from a first user Internet point and includes restricted and unrestricted portions accessible from any second user point via the Internet. To this end, an Internet information device includes a web site coupled to a first user intranet point and a second user Internet point. The first user point is coupled for providing managed information to the web site. The second user point is coupled for accessing the managed information provided by the first user. This managed information can be accessed by the first user by inputting a selected or computer generated password which can be either numeric, alpha, or both.

A principal advantage of this embodiment is that the user at the first point has instant access to the information and provides continuous updates at the website which reduces the need for repeated, time consuming direct contact with the user at the second point. In addition, the user at the second point can have access to immediate, up to date sales information provided by the user at the first point.

### BRIEF DESCRIPTION OF THE DRAWINGS

FIG. 1 is a diagrammatic view illustrating an embodiment of a network.

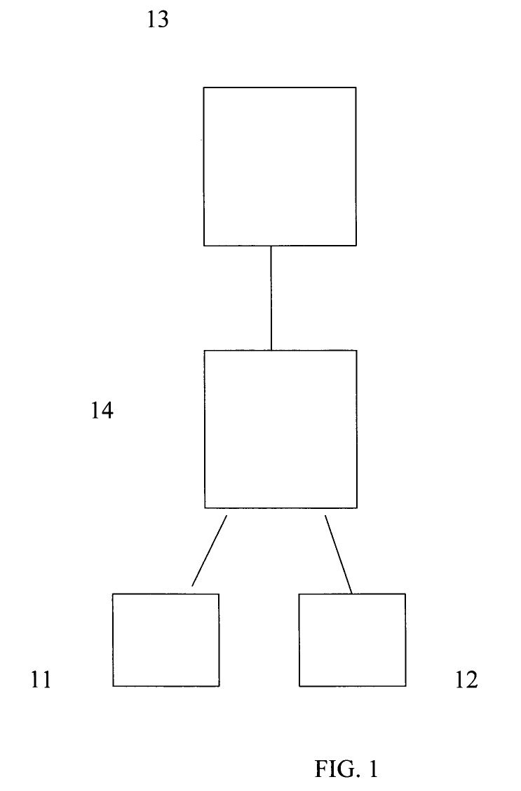

FIG. 2 is a diagrammatic view illustrating a FOR SALE sign using the present invention;

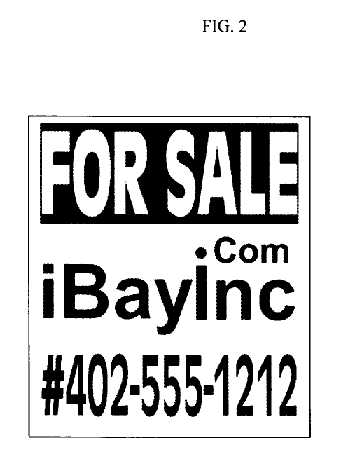

FIG. 3 is a diagrammatic view illustrating a FOR RENT sign using the present invention;

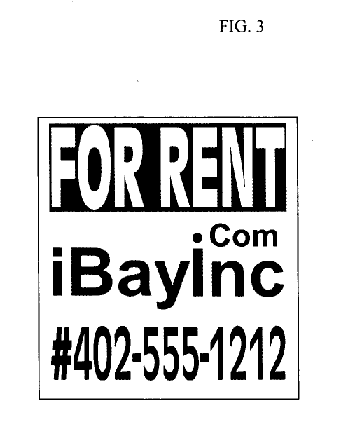

FIG. 4 is a diagrammatic view illustrating a GARAGE SALE sign using the present invention;

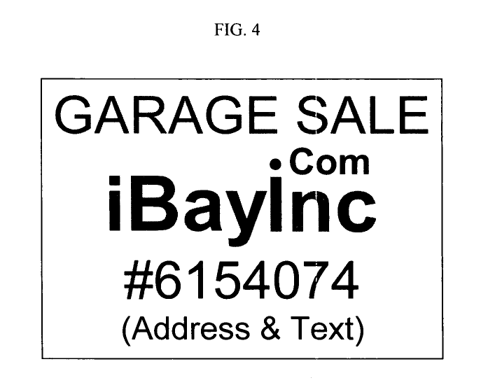

FIG. 5 is a diagrammatic view illustrating a classified ad using the present invention;

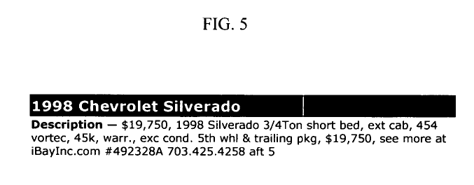

FIG. 6 is a diagrammatic view illustrating an identification string being entered to view managed information designated by a merchandise owner.

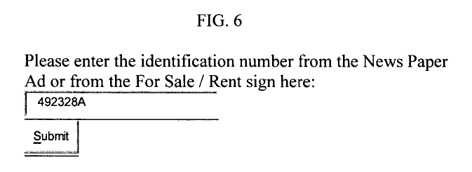

FIG. 7 is a diagrammatic view illustrating information and instructions provided by the seller being presented to the buyer for assistance in selling the merchandise

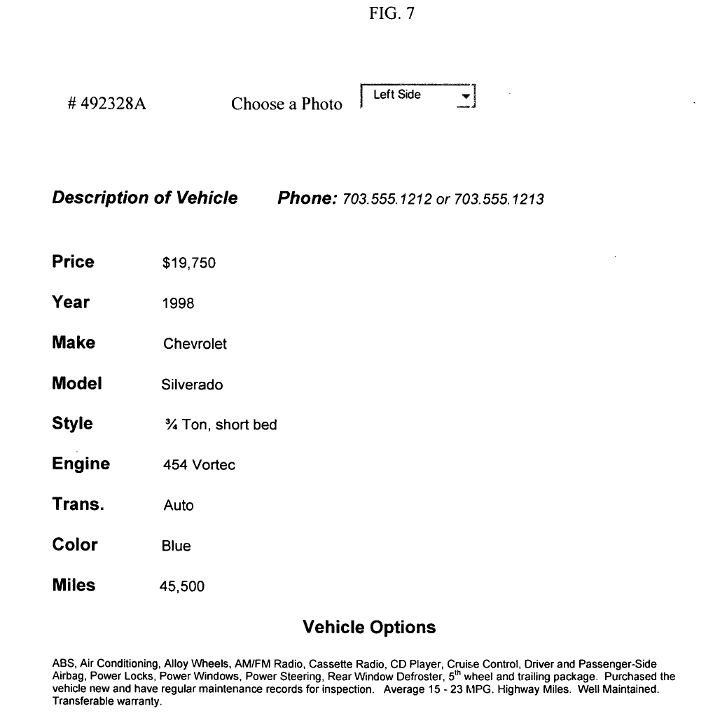

### DETAILED DESCRIPTION

Listed within a newspaper ad, on a FOR SALE, FOR RENT or GARAGE SALE sign, or when mentioned on radio, television and other advertising media, the seller provides the buyer with a computer generated or customized identification string. This number can be numeric, alpha or both. When viewed or listened to by the buyer, he/she is instructed to follow a specific course of action.

The buyer is prompted to go to a specific website address for additional information about the merchandise provided by the seller. Upon reaching the website, the buyer is instructed to enter the identification string made available by the seller. The buyer is then provided with instructions, photos and pertinent information provided by the seller.

### DETAILED DESCRIPTION OF THE PREFERRED EMBODIMENT

A network FIG. (1) includes a website provider (13), a website (14) having a web page or several pages coupled to a first user point (11) and a second user point (12). Any person from any terminal on any network used by a site provider or used via voice recognition software, can access public information at the website (14). The website (14) includes customized, managed information from the web site provider (13) and can do business with customers both a first user (11) and second user (12).

The first user point (11) as used in this context is any terminal on any network used by a site provider to input managed information to the web site, including access via voice recognition software, (14). The second user point (12) as used in this context is any terminal used by a site user via the Internet, or via voice recognition software, to access all or part of the managed information at the web site (14).

The site provider writes and manages the web site (13). The site user at first user point (11) has access to web site (14) from any remote access server which provides access to the Internet. Upon reaching the website (14) the first user (11) instructs the web site (14) to accomplish various tasks and manage information by entering an identification string from its communication port which includes a selected identification string and password.

The second user point (12) has access to the web site (14) from any remote access server which provides access to the Internet. Upon reaching the website (14) the second user (12) instructs the web site (14) to accomplish various tasks by entering an identification string from its communication port. The second user point (12) will have one (1) level of access associated with the selected identification string and can see only the managed information designated by the first user (11).

### Conclusion

Possibly the most important aspect of direct selling is the accuracy of the information being provided and the accessibility of the information to the buyer. The seller can maintain current sales information and provide the data to the buyer instantaneously via the Internet. This is of extreme importance to the buyer who wishes to learn more about the seller or merchandise before proceeding further.

### Ramifications

By providing an apparatus and method for continuously managing and updating essential information at a web site from a first access point, and providing necessary information and instructions to the second user point, coupled with the ability to maintain in progress sales information important to the buyer, is insurmountable to all parties involved in direct sales. Especially to those who are handicapped, do not have access to transportation to view the merchandise directly, are to sick or ill to leave the premises to inspect the merchandise or cannot get through to the seller via telephone.

### Scope

Even though the buyer of merchandise is instructed to follow a specific course of action from an identification string provided from all forms of advertising media, other forms of communication may exist and the apparatus and method for obtaining sales information to the second user point should not be limited to media advertising only.

Virtually any person using an identification string provided by the seller, which instructs the buyer to follow a specific course of action to connect buyer and seller via the Internet, including the use of voice recognition software, to obtain sales and merchandise information should be included.

1. An Internet information method comprising of a web site wherein a selected identification string, alpha, numeric, or both, that provides access to managed information from a first user point for users at a second user point.

2. The device as defined in claim 1 wherein the user at the first user point generates an identification string or a customized identification string that is included on, but not limited to, FOR SALE, FOR RENT, GARAGE SALE signs or included in classified ads.

3. The device as defined in claim I wherein a user at the second user point enters a system identifier from, as defined in claim 2, for routing the second user to the managed information provided by the first user.
